(19) United States
(12) Patent Application Publication
(10) Pub. No.: US 2015/0161369 A1
(43) Pub. Date: Jun. 11, 2015

(54) GRIP SIGNATURE AUTHENTICATION OF USER OF DEVICE

(71) Applicant: Lenovo (Singapore) Pte. Ltd., Singapore (SG)

(72) Inventors: Arnold S. Weksler, Raleigh, NC (US); Nathan J. Peterson, Durham, NC (US); Russell Speight VanBlon, Raleigh, NC (US)

(73) Assignee: LENOVO (SINGAPORE) PTE. LTD., Singapore (SG)

(21) Appl. No.: 14/098,180

(22) Filed: Dec. 5, 2013

(51) Int. Cl. G06F 21/32

(52) U.S. Cl. CPC G06F 21/32

(57) ABSTRACT

A method including receiving sensed information corresponding to a grip signature of a user holding a device, generating a grip signature from the sensed information, comparing the grip signature to a library of grip signatures, and authenticating the user based on the comparison to provide access to functions on the device.

### BACKGROUND

With current in-market technology, secure authentication on a handheld smart device requires entering a PIN/password, swiping a finger in a pattern, or swiping a finger across a fingerprint sensor that is placed in a specific location on the device. These actions are often perceived as cumbersome or too time consuming for high frequency use that is typical with smartphones. Some of the actions, such as a password or swipe may be seen by another user and used to gain unauthorized access. Still further methods of authentication may be quite complex, such as use of biometric information, facial detection, retinal detection, and others. As a result, many users value convenience over security and do not leverage available security measures, thereby leaving their device and data exposed.

### SUMMARY

A method including receiving sensed information corresponding to a grip signature of a user holding a device, generating a grip signature from the sensed information, comparing the grip signature to a library of grip signatures, and authenticating the user based on the comparison to provide access to functions on the device.

A machine readable storage device having instructions for execution by a processor of the machine to perform receiving sensed information corresponding to a grip signature of a user holding a device, generating a grip signature from the sensed information, comparing the grip signature to a library of grip signatures, and authenticating the user based on the comparison to provide access to functions on the device.

A device includes a processor, a sensor supported by the device, and a memory device having a program stored thereon for execution by the processor to receive sensed information from the sensor corresponding to a grip signature of a user holding a device, generate a grip signature from the sensed information, compare the grip signature to a library of grip signatures, and authenticate the user based on the comparison to provide access to functions on the device.

### BRIEF DESCRIPTION OF THE DRAWINGS

FIG. 1 is a perspective view of a hand held device having multiple sensors according to an example embodiment.

FIG. 2 is a representation of a hand held device being held by a user according to an example embodiment.

FIG. 3 is a flowchart illustrating a method of authenticating a user based on a grip signature derived from a hand held device according to an example embodiment.

FIG. 4 is a block diagram of computer system used to implement methods according to an example embodiment.

### DETAILED DESCRIPTION

In the following description, reference is made to the accompanying drawings that form a part hereof, and in which is shown by way of illustration specific embodiments which may be practiced. These embodiments are described in sufficient detail to enable those skilled in the art to practice the invention, and it is to be understood that other embodiments may be utilized and that structural, logical and electrical changes may be made without departing from the scope of the present invention. The following description of example embodiments is, therefore, not to be taken in a limited sense, and the scope of the present invention is defined by the appended claims.

The functions or algorithms described herein may be implemented in software or a combination of software and human implemented procedures in one embodiment. The software may consist of computer executable instructions stored on computer readable media such as memory or other type of hardware based storage devices, either local or networked. Further, such functions correspond to modules, which are software, hardware, firmware or any combination thereof. Multiple functions may be performed in one or more modules as desired, and the embodiments described are merely examples. The software may be executed on a digital signal processor, ASIC, microprocessor, or other type of processor operating on a computer system, such as a personal computer, server or other computer system. The article “a” or “an” means “one or more” unless explicitly limited to a single one.

Pressure sensing circuits (e.g. resistive and capacitive sensors), piezoelectric materials or other pressure-sensing solutions are embedded in or layered on top of a housing material for a handheld device like a smartphone, smart watch or other hand held electronic device. The sensing technology is positioned within the housing such that one or more sides of the device (possibly, but not necessarily including the display side) have pressing sensing capability to indicate grip mechanics applied to the device. As a result, this sensing capability can detect where a user's fingers and hand are gripping the device. The placement of the user hand on the device may be used as an authentication method. One or more finger placements may be used to authenticate the device in one embodiment.

In a further embodiment, the fingers may be required to be in a particular position while utilizing another authentication method, such as entering a password. For example, the thumb or index finger may be placed on a certain position while entering a password performing a gesture pattern with another finger. In further embodiments, the user may place, remove, and replace their grip multiple times to authenticate the user. In further embodiments a touch pattern may be used, where the user moves their finger or fingers to multiple locations. Finger sliding, rolling, tapping, press-and-hold, different amounts of pressure, and other motions of the fingers and grip may be used as input combinations for authentication in further embodiments. A further embodiment may include lifting one or more fingers and tapping them consistent with their positions gripping the device. After gripping the device, a user may lift their index finger and tap the device twice, followed by lifting the little finger commonly referred to as a pinky finger. Various patterns involving different fingers may be used in still further embodiments.

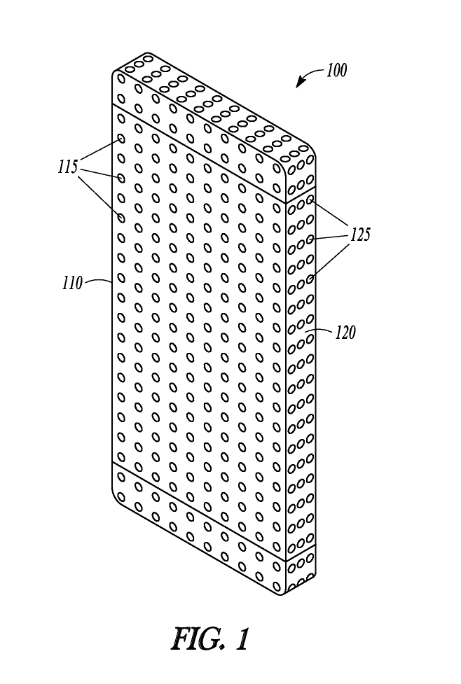

FIG. 1 is a perspective representation of a hand held device 100 having pressure sensing capability on left and right sides, and rear of a housing 110. An array of sensors 115 are represented as dots covering the housing of the hand held device. In one embodiment, the housing 110 is the case of the hand held device supporting interior electronics, buttons, and touch screen on a front side of the device 100 not visible in FIG. 1. In further embodiments, the housing may take the form of an external case that is shaped to hold the device 100 and connect via one or more electrical connectors.

A side 120 of the housing 110 corresponds to an edge of the housing 110, and may also have sensors 125 embedded on top of, or otherwise disposed on the side 120. Sensors 125 may also be similarly disposed on other sides of the housing 110. The sensors 115 and 125 have pressing sensing capability to indicate grip mechanics applied to the device 100. As a result, this sensing capability can detect fully where a user's fingers and hand are gripping the device.

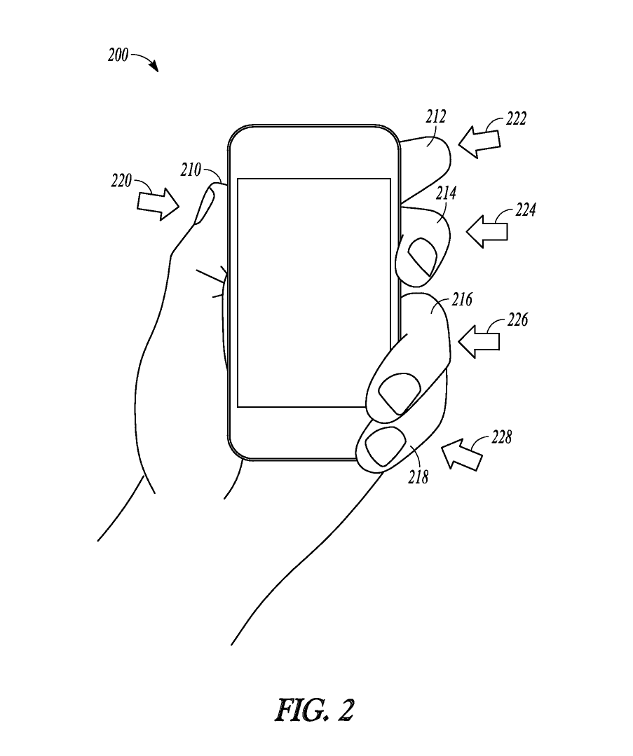

A natural grip of the device 100 as illustrated in FIG. 2 at 200 can be sensed by the sensors 115 and 125 to quickly authenticate the smartphone user with no conscious effort required from the user. Multiple fingers 210, 212, 214, 216, and 218 are shown, one or more of which may be contacting or may be near the device. The sensors in one embodiment are also capacitive proximity sensors which can detect how close a finger is to the sensors. FIG. 2 illustrates one example grip in which one or more fingers are at least partially contacting one or more edges of the device 200, resulting in sensors 115 and 125 detecting where the fingers are positioned. Such positioning and other data, such as the amount of pressure 220, 222, 224, 226, 228 respectively, and area of coverage of each finger may be detected. Such data may be referred to as the grip mechanics, and may vary in different embodiments, by either including or excluding different types of data.

The data obtained from the sensors 115 and 125 may be used to perform security checking and authenticate a user holding the device 100. The security measures may be two-fold in various embodiments. General pressure sensing can determine a grip signature on the device 100 that maps to a specific user. The grip signature may be used to match hand size, finger size, finger spread, contact point location and applied pressure to known patterns of registered users that may be stored in pattern library. In further embodiments, the proximity of one or more fingers or other parts of the hand may be included in the grip signature.

Additionally, pattern libraries may be improved over time. As the user authenticates across subsequent uses of the smart device, grip signature data may be recorded to improve/increase frequency of true-positive results. When specific elements of the grip signature, such as number of fingers, area of fingers contacting and proximate the device, pressure exerted by each finger, and other characteristics consistently are used by a user, these elements of aggregated data may become leading indicators in a hierarchy of available data. In essence, the strength of multiple, partial matches of the characteristics of the grip may be leveraged to provide highly secure authentication of a user while enabling a flexible “natural grip” usage model for the user.

In still further embodiments, a grip signature used for authentication may include the lifting of one or more fingers and tapping them. The tapping may occur in the same position as the fingers would be touching or proximate the device as occur when gripping the device. The user may, for example, lift an index finger and tap it twice in accordance with the grip, and then lift another finger, such as a little finger. In further embodiments, the tapping may occur on the device in positions different than the tapping finger may be used to grip the device. Many different patterns may be used, some of which may not be easily observable and copied surreptitiously to allow a third party to gain access to the device.

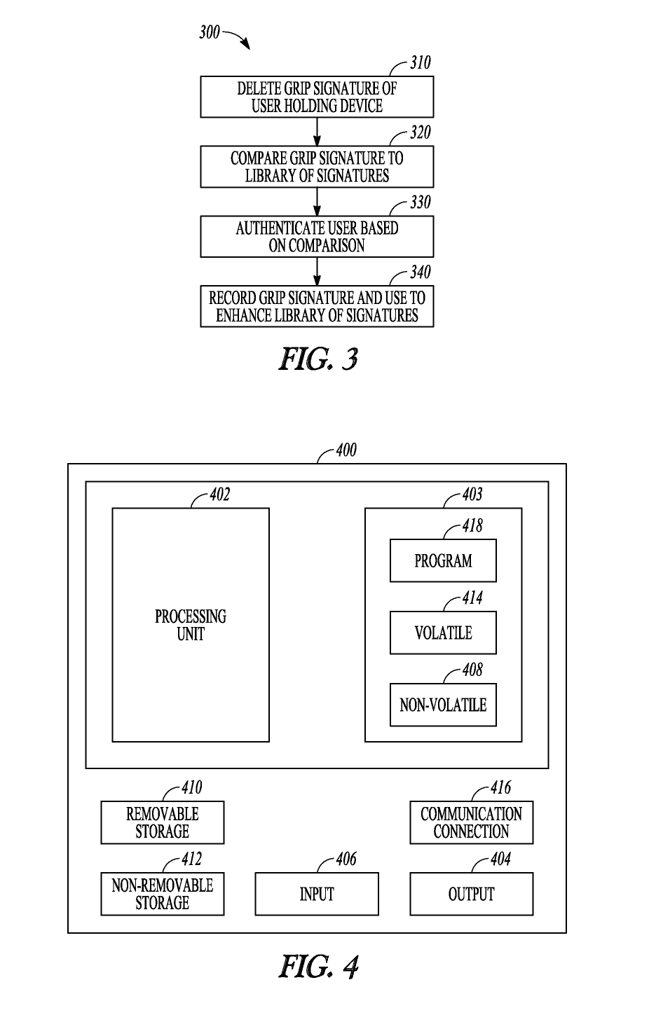

FIG. 3 is a flowchart illustrating a method 300 of using a grip signature to authenticate a user of a device. At 310, a grip signature generated by a user holding a device is detected. The sensors on the device provide grip information corresponding to the grip signature. The grip signature may include sensed information from which hand size, finger size, finger spread, contact point location, applied pressure and other characteristics may be generated.

The grip signature is compared at 320 to a library of signatures of known users. The grip signature may include one or more of the generated characteristics. The library of signatures may include signatures and variations of signatures used by a known user of the device, and may be stored on the device or in remote processing resources accessible by device. In further embodiments, the library of signatures may include signatures of multiple users that is searched to match the user holding the device. In either event, the signatures may be protected from access to ensure that the authentication process is secure. Thus, method 300 may execute on the device, or the sensed data may be sent to a remote server such as a cloud based server for execution of portions of the process 300, including authentication of the user at 330.

At 340, the detected grip signature may be recorded and added to the library of signatures as an example of a signature corresponding to an authenticated user. This may server to enhance the library of signatures and subsequent comparisons by including the logged signature as a signature that authenticates the user.

FIG. 4 is a block schematic diagram of a computer system 400 to implement device 100 and other computing resources according to example embodiments. All components need not be used in various embodiments. One example computing device in the form of a computer 400, may include a processing unit 402, memory 403, removable storage 410, and non-removable storage 412. Sensors 115 and 125 may be coupled to provide data to the processing unit 402. Memory 403 may include volatile memory 414 and non-volatile memory 408. Computer 400 may include—or have access to a computing environment that includes—a variety of computer-readable media, such as volatile memory 414 and non-volatile memory 408, removable storage 410 and non-removable storage 412. Computer storage includes random access memory (RAM), read only memory (ROM), erasable programmable read-only memory (EPROM) & electrically erasable programmable read-only memory (EEPROM), flash memory or other memory technologies, compact disc read-only memory (CD ROM), Digital Versatile Disks (DVD) or other optical disk storage, magnetic cassettes, magnetic tape, magnetic disk storage or other magnetic storage devices, or any other medium capable of storing computer-readable instructions. Computer 400 may include or have access to a computing environment that includes input 406, output 404, and a communication connection 416. Output 404 may include a display device, such as a touchscreen, that also may serve as an input device. The computer may operate in a networked environment using a communication connection to connect to one or more remote computers, such as database servers. The remote computer may include a personal computer (PC), server, router, network PC, a peer device or other common network node, or the like. The communication connection may include a Local Area Network (LAN), a Wide Area Network (WAN) or other networks.

Computer-readable instructions stored on a computer-readable medium are executable by the processing unit 402 of the computer 400. A hard drive, CD-ROM, and RAM are some examples of articles including a non-transitory computer-readable medium. For example, a computer program 418 capable of providing a generic technique to perform access control check for data access and/or for doing an operation on one of the servers in a component object model (COM) based system may be included on a CD-ROM and loaded from the CD-ROM to a hard drive. The computer-readable instructions allow computer 400 to provide generic access controls in a COM based computer network system having multiple users and servers.

### EXAMPLES

1. A method comprising:

receiving sensed information corresponding to a grip signature of a user holding a device;

generating a grip signature from the sensed information;

comparing the grip signature to a library of grip signatures; and

authenticating the user based on the comparison to provide access to functions on the device.

2.The method of example 1wherein the sensed information comprises sensed pressure detected by an array of pressure sensors.

3. The method of any of examples 1-2 wherein the grip signature includes contact point locations of a hand and fingers on the device.

4. The method of any of examples 1-3 wherein the grip signature includes hand size, finger size, and finger spread on the device.

5. The method of any of examples 1-4 wherein the grip signature includes contact points and applied pressure on the device.

6. The method of any of examples 1-5 and further comprising recording each grip signature that result in authentication of a user.

7. The method of example 6 and further comprising using recorded grip signatures to enhance the library of signatures.

8. The method of example 7 wherein the grip signature includes hand size, finger size, finger spread, contact point location, applied pressure.

9. The method of any of examples 1-8 wherein the grip signature includes a measure of proximity of at least one finger to the device.

10. The method of any of examples 1-9 wherein the grip signature includes a tap of the device by a user holding the device.

11. A machine readable storage device having instructions for execution by a processor of the machine to perform:

receiving sensed information corresponding to a grip signature of a user holding a device;

generating a grip signature from the sensed information;

comparing the grip signature to a library of grip signatures; and

authenticating the user based on the comparison to provide access to functions on the device.

12. The computer readable storage device of example 11 wherein the sensed information comprises sensed pressure detected by an array of pressure sensors.

13. The computer readable storage device of any of examples 11-12 wherein the method further comprises:

recording each grip signature that result in authentication of a user; and

using recorded grip signatures to enhance the library of signatures.

14. The computer readable storage device of any of examples 11-13 wherein the grip signature includes a measure of proximity of at least one finger to the device.

15. The computer readable storage device of any of examples 11-14 wherein the grip signature includes a tap of the device by a user holding the device.

16. A device comprising:

a processor;

a sensor supported by the device; and

a memory device having a program stored thereon for execution by the processor to:

receive sensed information from the sensor corresponding to a grip signature of a user holding a device;

generate a grip signature from the sensed information;

compare the grip signature to a library of grip signatures; and

authenticate the user based on the comparison to provide access to functions on the device.

17. The device of example 16 and further comprising:

a case enclosing the processor and memory device; and

wherein the sensor comprises an array of pressure sensors coupled to the case to sense holding of the case by a user.

18. The device of any of examples 16-17 and further comprising:

a case enclosing the processor and memory device; and

wherein the sensor comprises an array of capacitive sensors coupled to the case to sense proximity of a finger of a user holding of the case by a user.

19. The device of any of examples 16-18 wherein the program further causes the processor to record each grip signature that results in authentication of a user.

20. The device of example 19 wherein the program further causes the processor to use recorded grip signatures to enhance the library of signatures.

Although a few embodiments have been described in detail above, other modifications are possible. For example, the logic flows depicted in the figures do not require the particular order shown, or sequential order, to achieve desirable results. Other steps may be provided, or steps may be eliminated, from the described flows, and other components may be added to, or removed from, the described systems. Other embodiments may be within the scope of the following claims.

1. A method comprising:
receiving sensed information corresponding to a grip signature of a user holding a device;
generating a grip signature from the sensed information;
comparing the grip signature to a library of grip signatures; and
authenticating the user based on the comparison to provide access to functions on the device.

2. The method of claim 1 wherein the sensed information comprises sensed pressure detected by an array of pressure sensors.

3. The method of claim 1 wherein the grip signature includes contact point locations of a hand and fingers on the device.

4. The method of claim 1 wherein the grip signature includes hand size, finger size, and finger spread on the device.

5. The method of claim 1 wherein the grip signature includes contact points and applied pressure on the device.

6. The method of claim 1 and further comprising recording each grip signature that result in authentication of a user.

7. The method of claim 6 and further comprising using recorded grip signatures to enhance the library of signatures.

8. The method of claim 7 wherein the grip signature includes hand size, finger size, finger spread, contact point location, applied pressure.

9. The method of claim 1 wherein the grip signature includes a measure of proximity of at least one finger to the device.

10. The method of claim 1 wherein the grip signature includes a tap of the device by a user holding the device.

11. A machine readable storage device having instructions for execution by a processor of the machine to perform:
receiving sensed information corresponding to a grip signature of a user holding a device;
generating a grip signature from the sensed information;
comparing the grip signature to a library of grip signatures; and
authenticating the user based on the comparison to provide access to functions on the device.

12. The computer readable storage device of claim 11 wherein the sensed information comprises sensed pressure detected by an array of pressure sensors.

13. The computer readable storage device of claim 11 wherein the method further comprises:
recording each grip signature that result in authentication of a user; and
using recorded grip signatures to enhance the library of signatures.

14. The computer readable storage device of claim 11 wherein the grip signature includes a measure of proximity of at least one finger to the device.

15. The computer readable storage device of claim 11 wherein the grip signature includes a tap of the device by a user holding the device.

16. A device comprising:
a processor;
a sensor supported by the device; and
a memory device having a program stored thereon for execution by the processor to:
receive sensed information from the sensor corresponding to a grip signature of a user holding a device;
generate a grip signature from the sensed information;
compare the grip signature to a library of grip signatures; and
authenticate the user based on the comparison to provide access to functions on the device.

17. The device of claim 16 and further comprising:
a case enclosing the processor and memory device; and
wherein the sensor comprises an array of pressure sensors coupled to the case to sense holding of the case by a user.

18. The device of claim 16 and further comprising:
a case enclosing the processor and memory device; and
wherein the pressure sensor comprises an array of capacitive sensors coupled to the case to sense proximity of a finger of a user holding of the case by a user.

19. The device of claim 16 wherein the program further causes the processor to record each grip signature that results in authentication of a user.

20. The device of claim 19 wherein the program further causes the processor to use recorded grip signatures to enhance the library of signatures.
